(19) United States
(12) Patent Application Publication
(10) Pub. No.: US 2007/0076795 A1
(43) Pub. Date: Apr. 5, 2007

(54) Method and apparatus for determining inter-mode in video encoding

(75) Inventor: Nam-suk Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/505,923

(22) Filed: Aug. 18, 2006

(30) Foreign Application Priority Data
Oct. 1, 2005 (KR) 10-2005-0092660

(51) Int. Cl. H04N 11/02; H04N 11/04

(52) U.S. Cl. 375/240.16; 375/240.24

(57) ABSTRACT

A method of and apparatus are provided for determining an inter-mode in video encoding. The method includes calculating a motion vector by performing hierarchical motion estimation on a current block to be encoded in units of sub-pixels, storing reference area data indicated by the calculated motion vector in an internal memory, calculating a first cost by performing motion estimation in units of sub-pixels using the reference area data stored in the internal memory, calculating a second cost for the current block by performing motion estimation using a motion vector predicted, if reference area data indicated by the motion vector predicted calculated using motion vectors of neighboring blocks of the current block is included in the internal memory, and comparing the first-cost and the second cost and determining an inter-mode having the smallest cost.

### CROSS-REFERENCE TO RELATED PATENT APPLICATION

This application claims priority from Korean Patent Application No. 10-2005-0092660, filed on Oct. 1, 2005, in the Korean Intellectual Property Office, the disclosure of which is incorporated herein in its entirety by reference.

### BACKGROUND OF THE INVENTION

1. Field of the Invention

Methods and apparatuses consistent with the present invention relate to video encoding, and more particularly, to determining an inter-mode in video encoding.

2. Description of the Related Art

In an ITU-T H.264/MPEG-4 AVC (Advanced Video Coding) video codec, prediction is performed on block-based sample data to obtain a prediction block and video data is compressed by transforming and quantizing the prediction block.

There are two types of prediction, i.e., intraprediction and interprediction. In intraprediction, prediction is performed using data of neighboring blocks that have been encoded and decoded for reconstruction in a current slice. In interprediction, a prediction model is generated from at least one previously encoded video frame or field using block-based motion compensation. In particular, unlike in former video compression standards, in H.264, various block sizes ranging from 16×16 to 4×4 and fine sub-sample motion vectors are supported and a main profile and an extended profile support a bidirectional (B)-slice and weighted prediction. Video data compressed through prediction, transform, and quantization is compressed again through entropy encoding and becomes a bitstream according to the H.264 standard.

In general, a motion estimation unit is the most computationally intensive portion of a video encoder. To reduce the amount of computation of the motion estimation unit, various fast motion estimation methods have been developed. In other words, when full search in motion estimation is implemented with hardware, the size of an internal memory for storing data of a full search area increases. As a result, a hierarchical motion estimation method is used to reduce the size of the internal memory.

In H.264, when a motion vector of a macroblock included in a predictive (P) slice is the same as a motion vector predicted (MVP) or a motion vector of a macroblock included in a B slice is the same as a direct motion vector, a current macroblock is skipped. The skipped macroblock is given a predetermined mark indicating that it is skipped and is not encoded. However, values of the direct motion vector and the MVP are not within a predetermined value. This is because the direct motion vector and the MVP are predicted from a reference picture or calculated from a motion vector of a neighboring block. Thus, when a prediction mode of an encoder is determined, it is necessary to access an external memory and read data required for motion estimation for calculating a cost of the direct motion vector or the MVP. Such an access to the external memory imposes a load on a bus.

### SUMMARY OF THE INVENTION

The present invention provides a method of and apparatus for efficiently determining an inter-mode using reference area data stored in an internal memory in hierarchical motion estimation.

The present invention also provides a method of and apparatus for determining an inter-mode, in which a load on a bus is reduced and a processing time is reduced by using reference area data stored in an internal memory in hierarchical motion estimation without accessing an external memory in motion estimation of a direct motion vector and an MVP in inter-mode determination.

According to one aspect of the present invention, there is provided a method of determining an inter-mode in video encoding. The method includes calculating a motion vector by performing hierarchical motion estimation on a current block to be encoded in units of integer pixels, storing reference area data indicated by the calculated motion vector in an internal memory, calculating a first cost by performing motion estimation in units of integer-pixels using the reference area data stored in the internal memory, calculating a second cost for the current block by performing motion estimation using a motion vector predicted, if reference area data indicated by the motion vector predicted calculated using motion vectors of neighboring blocks of the current block is included in the internal memory, and comparing the first cost and the second cost and determining an inter-mode having the smallest cost.

According to another aspect of the present invention, there is provided an apparatus for determining an inter-mode in video encoding. The apparatus includes a hierarchical motion estimation unit, an internal memory, a sub-pixel motion estimation unit, a motion vector estimation unit, and an inter-mode determination unit. The hierarchical motion estimation unit calculates a motion vector by performing hierarchical motion estimation on a current block to be encoded in units of sub-pixels. The internal memory stores reference area data indicated by the calculated motion vector in an internal memory. The sub-pixel motion estimation unit calculates a first cost by performing motion estimation in units of sub-pixels using the reference area data stored in the internal memory. The motion vector estimation unit calculates a second cost for the current block by performing motion estimation using a motion vector predicted, if reference area data indicated by the motion vector predicted calculated using motion vectors of neighboring blocks of the current block is included in the internal memory. The inter-mode determination unit compares the first cost and the second cost and determines an inter-mode having the smallest cost.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a video encoder according to an exemplary embodiment of the present invention;

FIG. 2 is a detailed block diagram of a motion estimation unit of FIG. 1 according to an exemplary embodiment of the present invention;

FIG. 3 is a flowchart illustrating a method of determining an inter-mode according to an exemplary embodiment of the present invention;

FIG. 4 is a view for explaining hierarchical motion estimation performed by a hierarchical motion estimation unit of FIG. 2 according to an exemplary embodiment of the present invention;

FIG. 5 illustrates the structure of an internal memory included in the motion estimation unit according to an exemplary embodiment of the present invention; and

FIGS. 6A and 6B are views for explaining calculation of an MVP, performed by a motion vector estimation unit according to an exemplary embodiment of the present invention.

### DETAILED DESCRIPTION OF EXEMPLARY EMBODIMENTS OF THE INVENTION

Hereinafter, exemplary embodiments of the present invention will be described in detail with reference to the accompanying drawings.

A motion vector has a value that is similar to that of its neighboring motion vector. Such a relationship is called correlation between motion vectors. Since a motion vector in a direct mode (hereinafter, referred to as a direct motion vector) and an MVP are obtained using correlation, they are also similar to their neighboring motion vectors. The direct motion vector means a vector calculated from list 0 and list 1 reference pictures based on a previously coded motion vector for a macroblock or a macroblock partition in a B slice according to the H.264 standard. In the direct mode, for an interprediction encoded block, a motion vector is not transmitted and the direct motion vector is calculated from the reference pictures. The MVP is a vector calculated from a vector of a previously encoded neighboring block of a current block. The direct motion vector and the MVP are described in detail in the H.264 standard and a description thereof will not be provided.

Since hierarchical motion estimation uses correlation between motion vectors, there is a high possibility that reference area data indicated by the direct motion vector and the MVP is included in an internal memory that stores data used in hierarchical motion estimation. When the reference area data indicated by the direct motion vector and the MVP is not included in the internal memory, a cost may be large even if an external memory is accessed to read the reference area data and motion estimation and motion compensation are performed. In other words, in case of the reference area data being not included in the internal memory, the performance of the codec is not influenced even if motion compensation is not performed with respect to an inter-mode using the direct motion vector and the MVP.

Thus, in the present invention, by using reference area data stored in an internal memory of a motion estimation unit through hierarchical motion estimation, only when reference area data indicated by a direct motion vector or an MVP is stored in the internal memory, motion estimation using the direct motion vector and the MVP is performed, a cost is calculated, and an inter-mode is determined based on the calculated cost.

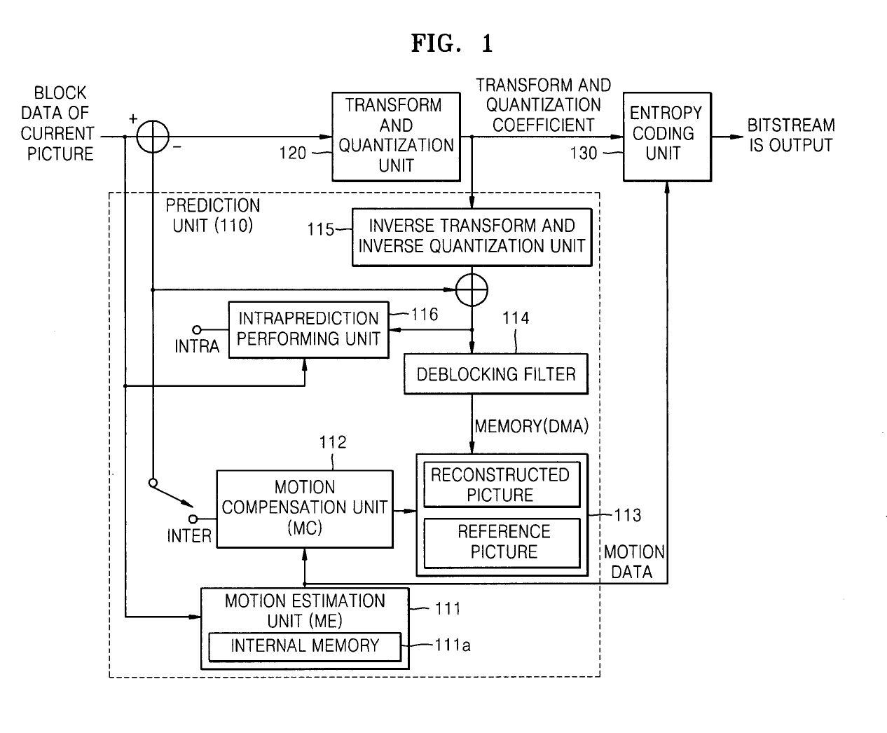

FIG. 1 is a block diagram of a video encoder according to an exemplary embodiment of the present invention.

Referring to FIG. 1, the video encoder includes a prediction unit 110, a transform and quantization unit 120, and an entropy coding unit 130. 1241 The prediction unit I 10 performs interprediction and intraprediction. In interprediction, a current block is predicted using a reference picture that is stored in a buffer after undergoing decoding and then deblocking filtering. In other words, prediction is performed using information between pictures. To this end, the prediction unit 110 includes a motion estimation unit 111 and a motion compensation unit 112. In intraprediction, a current block is predicted using pixel data of its neighboring block in an encoded and decoded picture. To this end, the prediction unit 110 includes an intraprediction performing unit 116. In the H.264 standard, macroblocks of a picture are arranged in slices, where an intra (I) slice can include only I macroblocks, a P slice can include P macroblocks and I macroblocks, and a B slice can include B macroblocks and I macroblocks. The I macroblocks are predicted through intraprediction from decoded sample data in a current slice and the P and B macroblocks are predicted through interprediction from a reference picture.

In particular, since the motion estimation unit 111 according to the present invention performs motion estimation using reference area data stored in an internal memory 111a of the motion estimation unit 111 in a plurality of inter-modes for an interpredicted P or B macroblock, macroblock partition, or sub-macroblock partition through hierarchical motion estimation and compares costs of the inter-modes to select one of the inter-modes, accessing an external memory is not required and a load on a bus and the processing time required for inter-mode determination can be reduced.

A reference picture or a reconstructed picture is stored in an external memory (not shown) such as synchronous dynamic random access memory (SDRAM). The motion estimation unit 111 includes the internal memory 111a. The external memory is directly accessed (direct memory access: DMA) via a bus, whereas it is not necessary to access the internal memory 111a via the bus. Thus, the internal memory 111a has the advantage of not imposing a load on the bus.

The transform and quantization unit 120 transforms and quantizes a residue that is a difference between a prediction sample obtained by the prediction unit 110 and the original video data.

The entropy coding unit 130 entropy-codes the quantized video data according to a predetermined method and outputs a bitstream according to the H.264 standard.

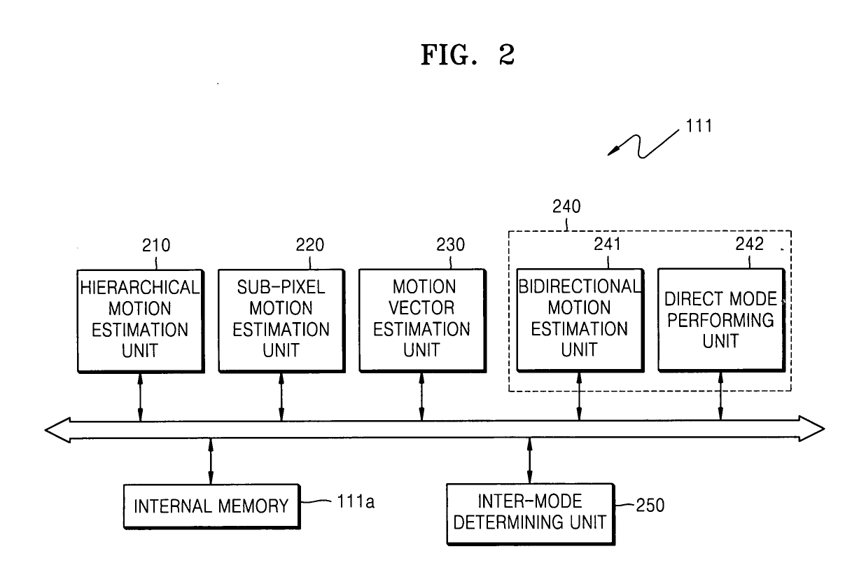

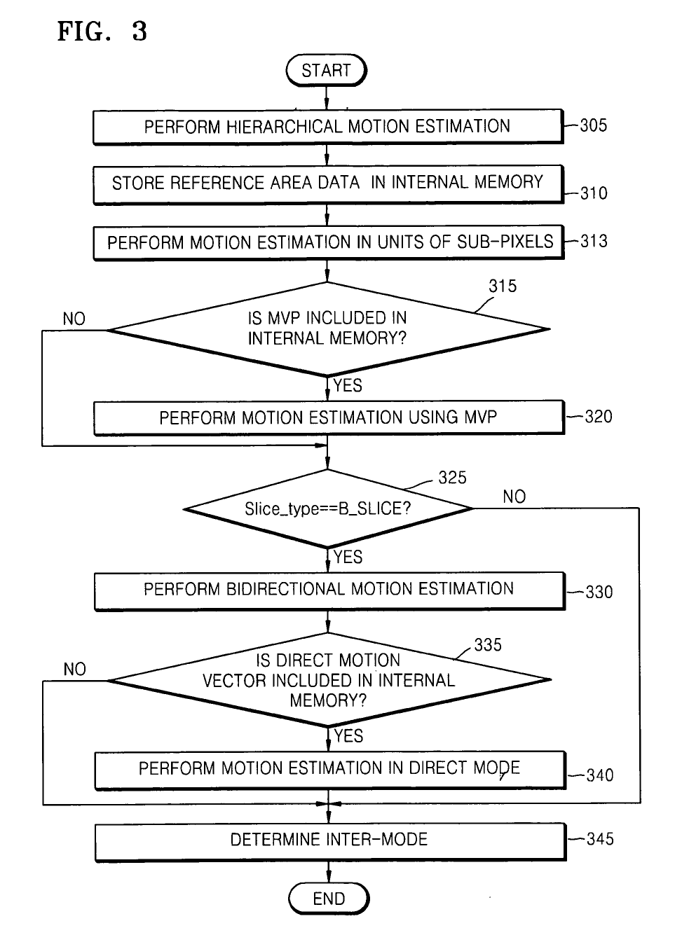

FIG. 2 is a detailed block diagram of the motion estimation unit 111 of FIG. 1 according to an exemplary embodiment of the present invention, and FIG. 3 is a flowchart illustrating a method of determining an inter-mode according to an exemplary embodiment of the present invention. Hereinafter, a method of and apparatus for determining an inter-mode according to exemplary embodiments of the present invention will be described in detail with reference to FIGS. 2 and 3.

The motion estimation unit 111 includes a hierarchical motion estimation unit 210, a sub-pixel motion estimation unit 220, a motion vector estimation unit 230, a B slice extension estimation unit 240, and the internal memory 111a. The B slice extension estimation unit 240 includes a bidirectional motion estimation unit 241 that performs bidirectional motion estimation and a direct mode performing unit 242 that performs interprediction in a direct mode when a current macroblock to be encoded is included in a B slice.

In operation 305, the hierarchical motion estimation unit 210 calculates a motion vector in units of integer pixels by performing hierarchical motion estimation on the current macroblock. Hierarchical motion estimation involves dividing the original frame into frames of various resolutions and hierarchically generating a motion vector for a frame of each resolution. In an exemplary embodiment of the present invention, the hierarchical motion estimation unit 210 may perform hierarchical motion estimation using multi-resolution multiple candidate search (MRMCS).

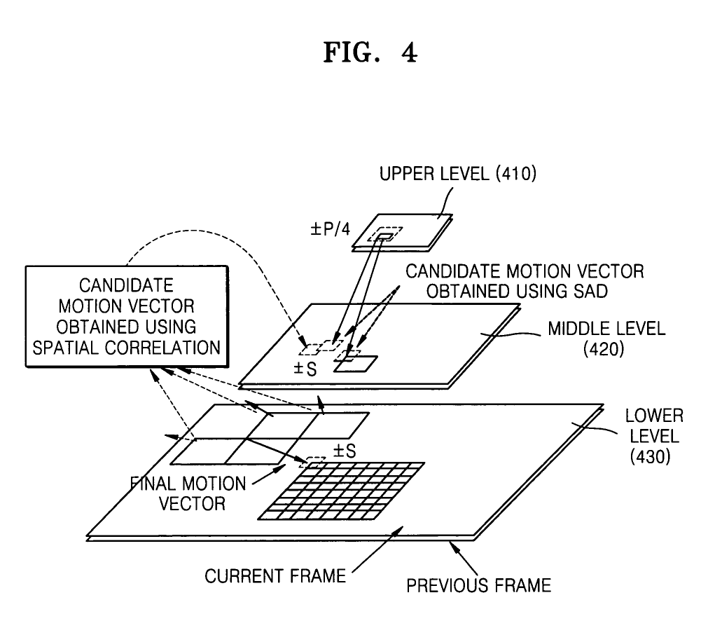

FIG. 4 is a view for explaining hierarchical motion estimation performed by the hierarchical motion estimation unit 210 of FIG. 2 according to an exemplary embodiment of the present invention. The hierarchical motion estimation unit 210 performs motion estimation in units of integer pixels.

Referring to FIG. 4, for hierarchical motion estimation, a current frame to be encoded and a previous frame are divided into a lower level 430 having the original resolution, a middle level 420 in which a lower-level video is decimated by 2 to lower the resolution, and an upper level 410 in which a middle-level video is decimated by 2 to lower the resolution. According to hierarchical motion estimation, motion estimation is performed using videos having resolutions and a search range varying with hierarchical levels, thereby making fast motion estimation possible.

More specifically, it is assumed that motion estimation is performed on each 16×16 macroblock and a search range of motion estimation is [−16, +16].

In a first step, in the upper level 410, a macroblock that is the most similar to a current macroblock whose size is reduced to ¼ of the original size, i.e., 4×4, is searched in a previous frame whose size is reduced to ¼ of the original size. A search range is [−4, +4]. In general, a sum of absolute differences (SAD) function is used as a matching reference value, i.e., a function for measuring similarity. An SAD is a sum of absolute values of differences between pixel values of a current macroblock and pixel values of a search macroblock. The most similar macroblock of the current macroblock and the next most similar macroblock of the current macroblock are determined using the SAD function and a motion vector for each of the most similar macroblock and the next most similar macroblock is obtained.

In a second step, in the middle level 220, a search is performed in a search range of [−s, +s] around two search points corresponding to the two motion vectors obtained in the first step and one search point corresponding to a motion vector obtained by taking a median value among determined motion vectors of three previously encoded macroblocks located to the left of, above, and above and to the right of the current macroblock in a previous frame whose size is reduced to ½ of the original size, thereby obtaining a macroblock that is the most similar to the current macroblock and a motion vector of the most similar macroblock. Here, s generally ranges between 2 and 4.

In a third step, in the lower level 430, a partial search is performed in a search range of [-s, +s] around a search point corresponding to the most similar macroblock obtained in the second step, i.e., the upper left vertex of the most similar macroblock, in the previous frame having the original size, thereby obtaining a macroblock that is the most similar to the current macroblock and a final motion vector of the most similar macroblock.

Next, in operation 310, the hierarchical motion estimation unit 210 accesses the external memory to read reference area data required for the lowest level for hierarchical motion estimation, i.e., the lower level 430 of FIG. 4, and stores the read reference area data in the internal memory 111a.

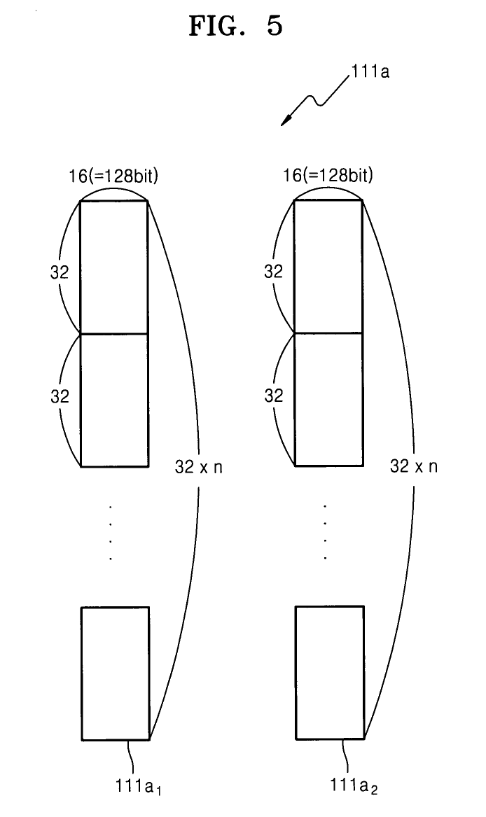

FIG. 5 illustrates the structure of the internal memory 111a included in the motion estimation unit 111 according to an exemplary embodiment of the present invention.

Referring to FIG. 5, when a number of reference areas referred to by a current block is n, the size of the current block is N×M, a search range in the lower level 430 for hierarchical motion estimation is [−a, +a] in a horizontal direction and [−b, +b] in a vertical direction, and the size of a reference area is (2a+N)×(2b+M), the internal memory 111a may include a plurality of N×(2b+M) storage units. In FIG. 5, when the number of reference areas referred to by the current block is n, the current block has a size of 16×16, the number of bits per pixel is 8, a search range is [−8, +8] in a horizontal direction and in a vertical direction, and the size of reference area data required in the lower level 430 as a result of hierarchical motion estimation is 32×32, the internal memory 111a includes two storage units 111a₁ and 111a₂ having a size of 16×32 n. The internal memory 111a structured as above reduces the number of gates used and can efficiently provide data in motion estimation.

Referring back to FIGS. 2 and 3, in operation 313, the sub-pixel motion estimation unit 220 performs motion estimation in units of sub-pixels using reference area data stored in the internal memory 111a through hierarchical motion estimation to calculate a first cost. In other words, the sub-pixel motion estimation unit 220 reads reference area data indicated by a motion vector resulting from sub-pixel-based motion estimation from the internal memory 111a and calculates the first cost using absolute values of differences between pixel values of the original video data and the read reference area data. For calculation of the first cost, the SAD function may be used.

In operation 315, the motion vector estimation unit 230 calculates an MVP and determines whether reference area data indicated by the MVP is included in the internal memory 111a. As mentioned above, since motion vectors of adjacent blocks have high correlation, a motion vector of a current block can be predicted from a motion vector of a previously encoded block adjacent to the current block.

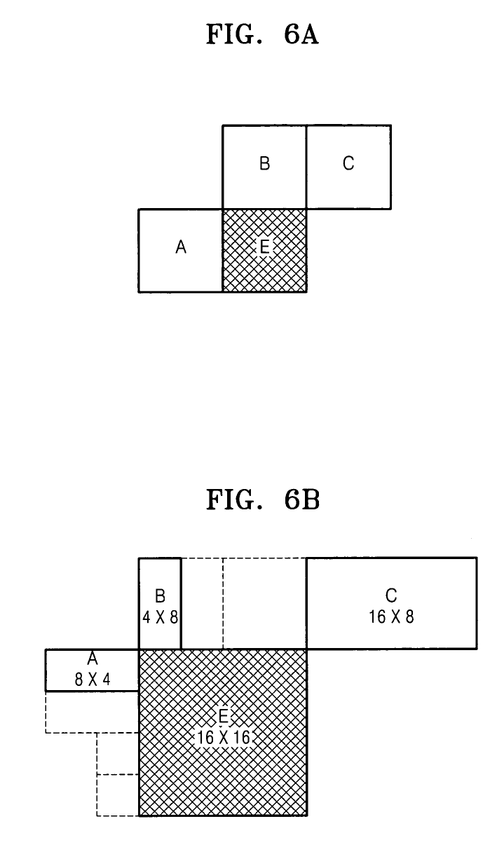

FIGS. 6A and 6B are views for explaining calculation of an MVP, performed by the motion vector estimation unit 230 according to the present invention. FIG. 6A is a view for explaining calculation of an MVP when a current block E and its neighboring blocks A, B, and C have the same size. FIG. 6B is a view for explaining calculation of an MVP when the current block E and its neighboring blocks A, B, and C have difference sizes. Referring to FIGS. 6A and 6B, the MVP of the current block E is calculated as follows.

(1) Except for a 16×8 or 8×16 portion of the current block E, the MVP of the current block E is calculated as a median value among motion vectors of the neighboring blocks A, B, and C.

(2) For 16×8 portions of the current block E, the MVP of the upper 16×8 portion is predicted from the neighboring block B and the MVP of the lower 16×8 portion is predicted from the neighboring block A.

(3) For 8×16 portions of the current block E, the MVP of the left 8×16 portion is predicted from the neighboring block A and the MVP of the right 8×16 portion is predicted from the neighboring block C.

(4) When the current block E is skipped, the MVP of the current block E is calculated as in (1).

If it is determined in operation 315 that the reference area data indicated by the calculated MVP is included in the internal memory 111a, the motion vector estimation unit 230 performs motion estimation using the MVP and calculates a second cost in operation 320. In other words, the motion vector estimation unit 230 reads the reference area data indicated by the calculated MVP from the internal memory 111a and calculates the second cost using absolute values of differences between pixel values of the original video data and the read reference area data. If it is determined in operation 315 that the reference area data indicated by the calculated MVP is not included in the internal memory 111a, the motion vector estimation unit 230 anticipates that a cost using the MVP would be large and does not perform motion estimation using the MVP.

In operation 325, it is determined whether the current block is included in a B slice. According to the H.264 standard, a block in the B slice is predicted in one of various modes such as a direct mode, a motion estimation mode using a list 0 reference picture, a motion estimation mode using a list 1 reference picture, and a bidirectional motion estimation mode using list 0 and list 1 reference pictures. In particular, the direct mode performing unit 242 according to the exemplary embodiment performs direct mode motion estimation only when a direct motion vector calculated in the direct mode is included in the internal memory 111a. If the direct motion vector calculated in the direct mode is not included in the internal memory 111a, the direct mode performing unit 242 anticipates that a cost of motion estimation and motion compensation using the MVP would be large and does not perform motion estimation and motion compensation using the direct motion vector.

In operation 330, the bidirectional motion estimation unit 241 calculates a third cost of the current block by performing bidirectional motion estimation on the current block included in the B slice. Bidirectional motion estimation uses an average of prediction samples extracted from the two list 0 and list 1 reference pictures. In other words, the bidirectional motion estimation unit 241 calculates the third cost using a difference between absolute differences between the average of the prediction samples extracted from the list 0 and list 1 reference pictures and the original video data.

In operation 335, the direct mode performing unit 242 calculates a direct motion vector of the current block in the direct mode using the reference area data stored in the internal memory 111a and determines whether reference area data indicated by the direct motion vector is included in the internal memory 111a in operation 335. If the reference area data indicated by the direct motion vector is included in the internal memory 111a, the direct mode performing unit 242 calculates a fourth cost of the current block using the direct motion vector in operation 340. More specifically, in the direct mode, for interprediction of a block included in a B slice, list 0 and list 1 vectors are calculated based on a vector of a previously encoded block and a direct motion vector is calculated from the calculated list 0 and list 1 vectors. The direct motion vector is described in the H.264 standard and a description thereof will not be provided. Next, the direct mode performing unit 242 reads the reference area data indicated by the direct motion vector from the internal memory 111a and calculates the fourth cost using absolute values of differences between pixel values of the read reference area data and the original video data.

In operation 345, an inter-mode determination unit 250 determines an inter-mode having the smallest cost by comparing the first through fourth costs. When some of the first through fourth costs cannot be calculated due to the type of a slice including the current block or the type of the current block, an inter-mode having the smallest cost among available costs is determined. For cost calculation, a sum of absolute transformed differences (SATD) or a sum of squared differences (SSD) may be used in addition to an SAD.

As described above, according to the present inventing, when a motion vector of a current block used in various inter-modes is not included in an internal memory, an inter-mode using the motion vector is skipped by anticipating that a cost of motion estimation would be large based on correlation between motion vectors, thereby reducing the processing time required for inter-mode determination without having an influence upon video quality. Moreover, according to the present invention, an internal memory included in a motion estimation unit is used without a need to access an external memory, thereby reducing a load on a bus caused by an access to the external memory and a processing time to determine an inter-mode among a plurality of inter-modes.

Meanwhile, the present invention can also be embodied as a computer-readable code on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and carrier waves. The computer-readable recording medium can also be distributed over network coupled computer systems so that the computer-readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of determining an inter-mode for video encoding, the method comprising:
calculating a motion vector by performing hierarchical motion estimation on a current block of a video picture to be encoded in units of integer-pixels;
storing reference area data indicated by the calculated motion vector in a memory;
calculating a first cost for the current block by performing motion estimation in units of sub-pixels using the reference area data stored in the memory;
calculating a second cost for the current block by performing motion estimation using a motion vector predicted, if reference area data indicated by the motion vector predicted calculated using motion vectors of neighboring blocks of the current block is stored in the memory; and
determining an inter-mode having a smallest cost by comparing the first cost and the second cost.

2. The method of claim 1, further comprising, if the current block is included in a bidirectional (B) slice, calculating a third cost for the current block by performing bidirectional motion estimation, wherein the determining the inter-mode having the smallest cost comprises determining the intermode having the smallest cost by comparing the first, second and third costs.

3. The method of claim 2, further comprising, if reference area data indicated by the direct motion vector of the current block calculated in a direct mode using the reference area data stored in the memory is stored in the memory, calculating a fourth cost for the current block using a direct motion vector, wherein the determining the inter-mode having the smallest cost comprises comparing the first, second, third and fourth costs.

4. The method of claim 3, wherein the first, second, third and fourth costs are calculated using absolute values of differences between pixel values of the reference area data resulting from motion estimation and original video data.

5. The method of claim 1, wherein the memory includes a plurality of N×(2b+M) storage units, where a number of reference areas referred to by the current block is n, a size of the current block is N×M, a search range is [−a, +a] in a horizontal direction and [−b, +b] in a vertical direction, and a size of the reference area is (2a+N)×(2b+M).

6. The method of claim 1, wherein hierarchical motion estimation is performed using a multi-resolution multiple candidate search.

7. The method of claim 3, wherein the first, second, third and fourth costs are calculated using a sum of absolute transformed differences or a sum of squared differences between pixel values of the reference area data resulting from motion estimation and original video data.

8. An apparatus for determining an inter-mode for video encoding, the apparatus comprising:
a hierarchical motion estimation unit which calculates a motion vector by performing hierarchical motion estimation on a current block of a video picture to be encoded in units of integer-pixels;
a memory which stores reference area data indicated by the calculated motion vector;
a sub-pixel motion estimation unit which calculates a first cost for the current block by performing motion estimation in units of sub-pixels using the reference area data stored in the memory;
a motion vector estimation unit which calculates a second cost for the current block by performing motion estimation using a motion vector predicted, if reference area data indicated by the motion vector predicted calculated using motion vectors of neighboring blocks of the current block is included in the memory; and
an inter-mode determination unit determines an inter-mode having a smallest cost by comparing the first cost and the second cost.

9. The apparatus of claim 8, further comprising a bidirectional motion estimation unit which calculates a third cost for the current block by performing bidirectional motion estimation, if the current block is included in a bidirectional (B) slice,
wherein the inter-mode determination unit compares determines the inter-mode having the smallest cost by comparing the first, second third costs.

10. The apparatus of claim 8, further comprising a direct mode performing unit which calculates a fourth cost for the current block using a direct motion vector, if reference area data indicated by the direct motion vector of the current block calculated in a direct mode using the reference area data stored in the memory is included in the memory,
wherein the inter-mode determination unit determines the inter-mode having the smallest cost by comparing the first, second, third and fourth costs.

11. The apparatus of claim 10, wherein the first through fourth costs are calculated using absolute values of differences between pixel values of the reference area data resulting from motion estimation and original video data.

12. The apparatus of claim 8, wherein the memory includes a plurality of N×(2b+M) storage units, where a number of reference areas referred to by the current block is n, a size of the current block is N×M, a search range is [−a, +a] in a horizontal direction and [−b, +b] in a vertical direction, and a size of a reference area is (2a+N)×(2b+M).

13. The apparatus of claim 8, wherein the hierarchical motion estimation unit performs hierarchical motion estimation using a multi-resolution multiple candidate search.

14. The apparatus of claim 10, wherein the first, second, third and fourth costs are calculated using a sum of absolute transformed differences or a sum of squared differences between pixel values of the reference area data resulting from motion estimation and original video data.
